(19) United States
(12) Patent Application Publication
(10) Pub. No.: US 2017/0282350 A1
(43) Pub. Date: Oct. 5, 2017

(54) PROTECTIVE GUARD FOR CIRCULAR BLADES

(71) Applicant: AVANTOR PERFORMANCE MATERIALS, LLC, Center Valley, PA (US)

(72) Inventors: Mark Christopher Wilson, Chino, CA (US); Rocky Allyn Courtain, Pinon Hills, CA (US)

(73) Assignee: AVANTOR PERFORMANCE MATERIALS, LLC, Center Valley, PA (US)

(21) Appl. No.: 15/474,392

(22) Filed: Mar. 30, 2017

Related U.S. Application Data
(60) Provisional application No. 62/315,381, filed on Mar. 30, 2016.

(51) Int. Cl. B25H 3/00; B23D 59/00; B27B 5/29

(52) U.S. Cl. CPC B25H 3/00; B27B 5/29; B23D 59/00

(57) ABSTRACT

A protective guard for a circular blade having a plurality of projecting edges along the circumference is provided. The protective guard includes an anchor link with a first member, a latching link detachably connectable to the anchor link, and a plurality of connected pivoted links extending between and connected to the anchor link and the latching link. The first member is adapted to engage one of the plurality of projecting edges of the circular blade, the plurality of connected pivoted links are adapted to cover the plurality of projecting edges along the circumference of the circular blade and the latching link is connected to the anchor link to secure the protective guard to the circular blade.

This application claims priority from provisional application Ser. No. 62/315,381, filed on Mar. 30, 2016, which is incorporated herein in its entirety.

### FIELD OF THE INVENTION

The present invention relates to protective guards for rotary blades used for mixing or cutting and having a plurality of projecting edges on the circumference. In particular, the present invention relates to protective guards for circular blades and impellers.

### BACKGROUND OF THE INVENTION

Mechanical mixers and dissolvers include blades on the circumference for mixing and dispersing materials in a container. These blades can include sharp edges and sometimes teeth along the outer circumference of the blade. High shear blades for mixing and dispersing applications typically include teeth with sharp edges. The leading edge design provides good, rapid dispersions. Such blades are most effective when completely exposed and available to the mixture. Similarly, circular blades used for circular cutting devices, such as circular saws, also have a plurality of sharp edges on the circumference.

Cleaning mechanical mixers or circular cutting devices, or replacement of the blades can result in injury to the operator. Hence, a continuing need exists for protecting users by covering such blades when performing maintenance or replacement.

### SUMMARY OF THE INVENTION

The present invention is a protective guard for a circular blade having a plurality of projecting edges along the circumference. The protective guard comprises, consists of or consists essentially of an anchor link with a first member, a latching link detachably connectable to the anchor link, and a plurality of connected pivoted links extending between and connected to the anchor link and the latching link. The first member of the anchor link engages one of the plurality of projecting edges of the circular blade. The plurality of connected pivoted links are then placed over the plurality of projecting edges along the circumference of the circular blade and the latching link is connected to the anchor link to secure the protective guard to the circular blade. The anchor link, the latching link and/or the plurality of connected pivoted links can be made from a polymeric material.

In one embodiment, the latching link includes a latching device formed by a flexible member having top and bottom sides. The top side is attached to the interior of the top wall of the latching link and the bottom side has a first detachably engageable surface. The exterior top wall of the anchor link has a second detachably engageable surface. The latching link and the anchor link can be connected and disconnected by engaging and disengaging the first and second detachably engageable surfaces.

In another embodiment, the anchor link has a first part of a hook and loop fastener on an outer surface thereof and the latching link has a second part of the hook and loop fastener on an inner surface thereof. The hook and loop fastener are engaged to connect the latching link and the anchor link. The latching link can also include a handle that facilitates the installation and removal of the protective guard and/or a U-shaped clip that is detachably connected to the anchor link.

The anchor link can have a U-shaped body comprising, consisting of or consisting essentially of a first side wall and a second side wall extending downwardly from opposing sides of a top wall to define an interior and an exterior, a first open end, and a second open end. The first member extends from the interior of the first side wall towards the second side wall at the first open end and, at the second open end, each of the first and second side walls has either a stud on the interior or an aperture therethrough. The first member of the anchor link can extend between the first and second side walls. Preferably, a second member extends from the interior of the second side wall of the anchor link towards the first member so that the first and second members define a space therebetween.

The latching link can have a U-shaped body comprising, consisting of or consisting essentially of a first side wall and a second side wall extending downwardly from opposing sides of a top wall to define an interior and an exterior, a first open end, and a second open end. A latching device extends from the first end and, at the second open end, each of the first and second side walls has either a stud on the interior or an aperture therethrough. The studs or apertures are used to connect the latching link to one of the plurality of connected pivoted links. The U-shaped body of the latching link can also comprise, consist of or consist essentially of a first section having an interior perimeter formed by the first side wall, the second side wall and the top wall and extending from the first open end to an intermediate point and a second section having an exterior perimeter formed by the first side wall, the second side wall and the top wall and extending from the second open end to the intermediate point. The interior perimeter of the first section is greater than the exterior perimeter of the anchor link so that the first section can be installed over the anchor link. The second section of the latching link has an interior perimeter greater than the exterior perimeter of a pivoted link so that the pivoted link can be inserted into the second section of the latching link.

The U-shaped body of the latching link can further comprise a third section disposed between the first and second sections. In some embodiments, the exterior top wall of the first section of the latching link is angularly disposed to the exterior top wall of the second section of the latching link at an angle of from 160 to 175 degrees.

Each of the plurality of connected pivoted links has a U-shaped body comprising, consisting of or consisting essentially of a first side wall and a second side wall extending downwardly from opposing sides of a top wall to define an interior and an exterior, a first open end, a second open end. Each of the plurality of connected pivoted links also has a first section having an interior perimeter formed by the first side wall, the second side wall and the top wall and extending from the first open end to an intermediate point and a second section having an exterior perimeter formed by the first side wall, the second side wall and the top wall and extending from the second open end to the intermediate point. In one embodiment, the interior perimeter of the first section is greater than the exterior perimeter of the second section. In another embodiment, the interior perimeter of the first section is less than the exterior perimeter of the second section.

Each of the plurality of connected pivoted links has a first stud and a second stud extending from the interior of the first and second side walls, respectively, at the first end and a first aperture and a second aperture extending through the first and second side walls, respectively, at the second end. The first link of the plurality of connected pivoted links is connected to a second link of the plurality of connected pivoted links by inserting the second end of the first link into the first end of the second link so that the first and second studs of the second link are pivotably engaged by the first and second apertures of the first link. It is within the scope of the present invention to switch the location of the studs from the interior surfaces of the first and second side walls on the first open end to the interior surfaces of the first and second side walls on the second open end and to switch the apertures from the second open end to the first open.

The protective guard can also include a locking device having a first part and a second part. The first part comprises, consists of or consists essentially of an elongate member having a U-shaped first end, a forked second end with two distal ends that define a slot, and an aperture extending through the top and bottom surfaces at the second end. Each of the two distal ends has a lip formed on the top and bottom surfaces, respectively, of the elongate member. The second part comprises, consists of or consists essentially of a substantially flat rectangular body having first and second sides and first and second ends. The body has an aperture near the first end and a notch in the first side near the second end. The aperture is adapted to receive the forked second end of the first part and the lips are adapted to secure the first part to the second part when the locking device is placed over the latching link. In preferred embodiments, the elongate member has an aperture near the second end and, after the elongate member passes through the aperture in the second part, a lock is inserted in the aperture of the elongate member to secure the elongate member in the second part.

The first member of the anchor link is adapted to engage one of the plurality of projecting edges of the circular blade and a first of the plurality of connected pivoted links is connected to the anchor link. The plurality of connected pivoted links is adapted to cover the plurality of projecting edges along the circumference of the circular blade. The second open end of the latching link engages a last of the plurality of connected pivoted links and the latching link is detachably connected to the anchor link to secure the protective guard to the circular blade.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIGS. 1A-D show a circular blade having a plurality of sharp edges or teeth and a protective blade guard according to an embodiment of the present invention. FIG. 1A shows the circular blade and the protective blade guard prior to installation. FIG. 1B shows the protective blade guard partially installed on the blade. FIG. 1C shows the protective blade guard completely covering and surrounding an outer edge of the blade. FIG. 1D illustrates a plurality or connected pivoted links of the main body of the protective blade guard.

FIGS. 2A-C show a peripheral, side, and end views of an anchor link of the protective blade guard according to an embodiment of the present invention.

FIGS. 3A-C show a peripheral, side, and end views of a connected pivoted link of the protective blade guard according to an embodiment of the present invention.

FIGS. 4A-D show a peripheral bottom, peripheral top, end, and side views of a latching link of the protective blade guard according to an embodiment of the present invention.

FIGS. 5A-D show top peripheral and bottom peripheral views of an anchor link and top peripheral and bottom peripheral views of a latching link of the protective blade guard according to an embodiment of the present invention

FIGS. 6A-B show a two-part locking device that secures the protective blade guard on a circular blade.

FIGS. 7A-D show the two-part locking device shown in FIGS. 6A-B installed on a circular blade.

FIG. 8 shows a clip that is used to attach the latching link of the protective blade guard to the anchor link.

### DETAILED DESCRIPTION OF THE PREFERRED EMBODIMENTS

The present invention relates to a protective guard for surrounding and covering a circular blade that is used in rotating, mechanical saws, mixers or dissolvers, particularly a blade with teeth such as an impeller blade, or the teeth of a rotary cutting device. Blades used for mechanical mixers and dissolvers are typically completely exposed when idle. Cleaning, maintaining or replacing such blades creates risk of injury. The protective blade guard reduces or eliminates the risk of injury by covering the teeth of the blade. The protective blade guards of the present invention allow an operator to change impeller blades without being exposed to sharp edges.

The protective guards comprise an anchor link that attaches to a tooth on a blade, a latching link that is detachably connected to the anchor link, and a plurality of pivoted links connected in series and extending between the anchor link and the latching link. One or more of the plurality of connected pivoted links can be added or removed to customize the protective guard to fit circular blades having different circumferences. For example, several pivoted links can be added or subtracted from the blade guard to adjust the guard to fit blades ranging in diameter from about 4 inches to about 36 inches or greater (or the equivalent in centimeters of about 10 cm to about 91.4 cm or greater). Each of the plurality of pivoted links comprises a top wall with two side walls extending downwardly from the opposing sides to form a continuous U-shaped body for covering teeth of a circular blade. The pivoted links, the anchor link and/or the latching link can be made from a polymeric material, e.g., a nylon or polyacetal. The anchor link can include one part of a hook and loop fastener on a surface thereof and the latching link can include the other part of the hook and loop fastener on a surface thereof. When the latching link is positioned on the anchor link, they can be connected by engaging the hook and loop fastener. The latching link can include a handle for easy removal of the latching link from the anchor link or a U-shaped clip for attaching the latching link to the anchor link.

In an embodiment of the protective blade guard of the present invention, the latching link is configured to attach to the anchor link to secure the protective guard on the blade. For example, the latching link can be press fit, or snap-fitted onto the anchor link. Alternatively, the latching link can be attached to the anchor link applying a detachably engageable material to the adjoining surfaces, such as VELCRO®. For example, a VELCRO® strip can be attached to the exterior top wall of the anchor link and to the bottom surface of a flexible latching device on the latching link. In another embodiment, the anchor link can have one part of a hook and loop fastener on a surface thereof and the latching link can have the other part of the hook and loop fastener on a surface thereof so that when the latching link is positioned on the anchor link the hook and loop fastener can be engaged. Advantageously, the latch link can include a handle, e.g., a strap with a loop, to facilitate release of the latch link from the anchor link. A U-shaped clip can also be inserted through the loop and clipped onto the anchor link or one of the connected pivoted links to secure the protective guard in place.

The components of the blade guard, e.g., the anchor link, the connected pivoted links, and latch link, can be made of any material; although metals are less desirable because of cost considerations. Preferably, the components of the blade guard are made from a stiff and durable plastic or rubber that can withstand repeated contact with a circular blade without tearing. In one embodiment of the present invention, one or more of the plurality of pivoted links comprises a polymeric material, e.g., a nylon such as nylon 66), polyacetal, rubber, urethane, acrylonitrile butadiene styrene (“ABS”) or other polymeric material having high stiffness, low friction and good dimensional stability. In certain embodiments, it is preferable that the one or more of the plurality of pivoted links comprises a polymeric material that is resistant to solvents; such polymeric materials include nylon 66 and polyacetal. The anchor link or the latching link or both can comprise the same polymeric materials as the one or more connected pivoted links. Advantageously, the components of the blade guard can have a safety color, e.g., red, yellow, etc. to signify or alert an operator to a potential risk of injury.

As used herein the term “circular blade” relates to any impeller blade or blade for a circular cutting device that has a plurality of irregular, projecting edges or teeth extending along the circumference and rotates to mix and/or cut materials.

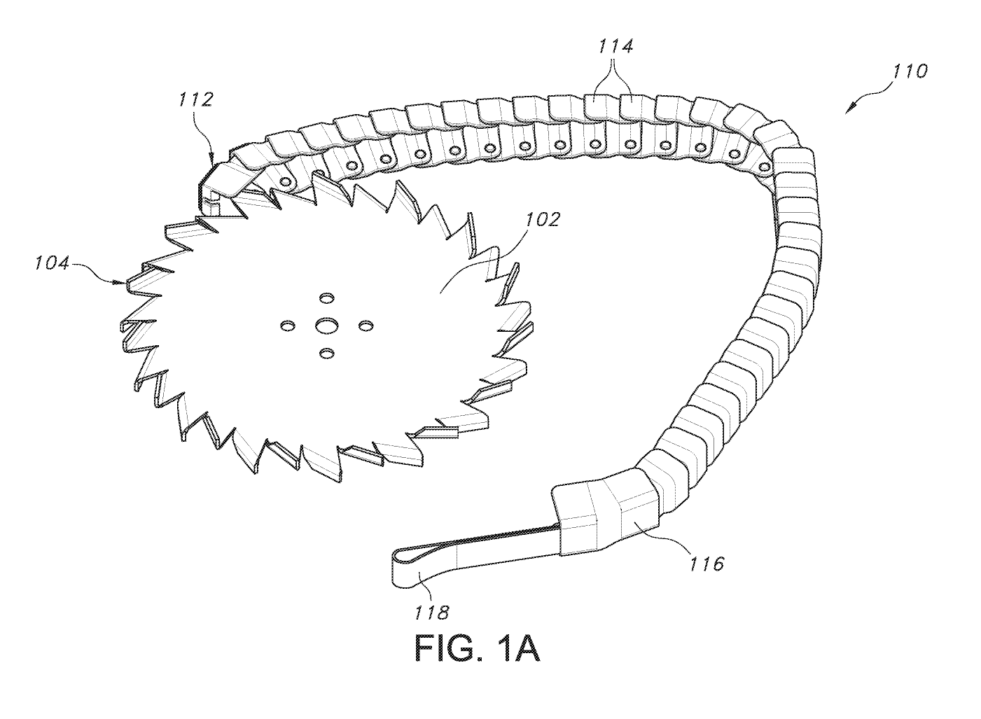

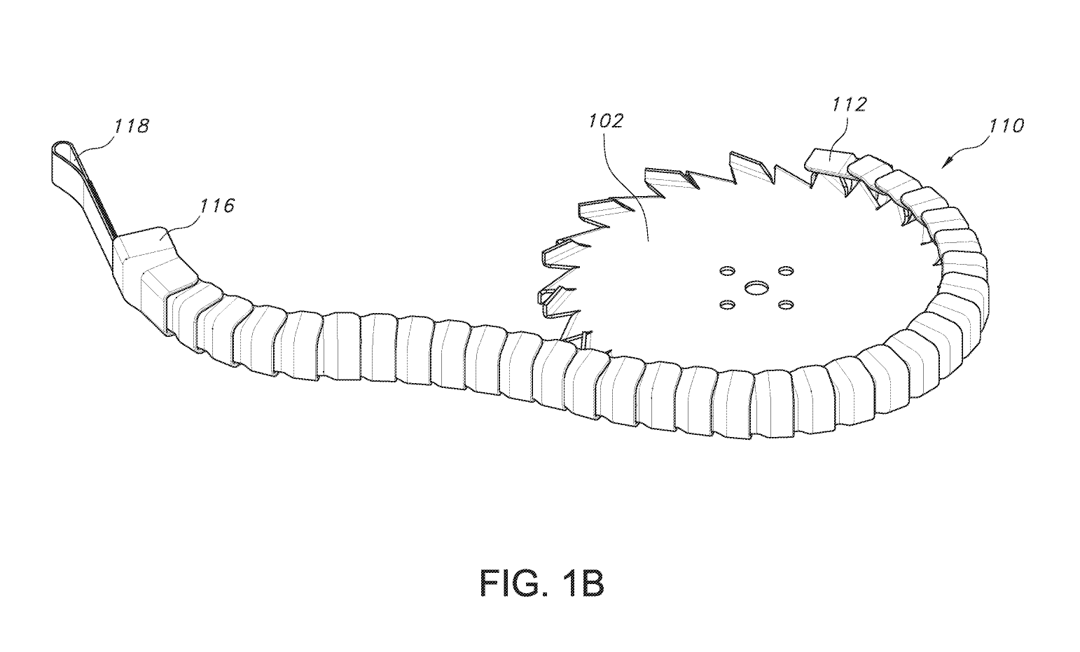

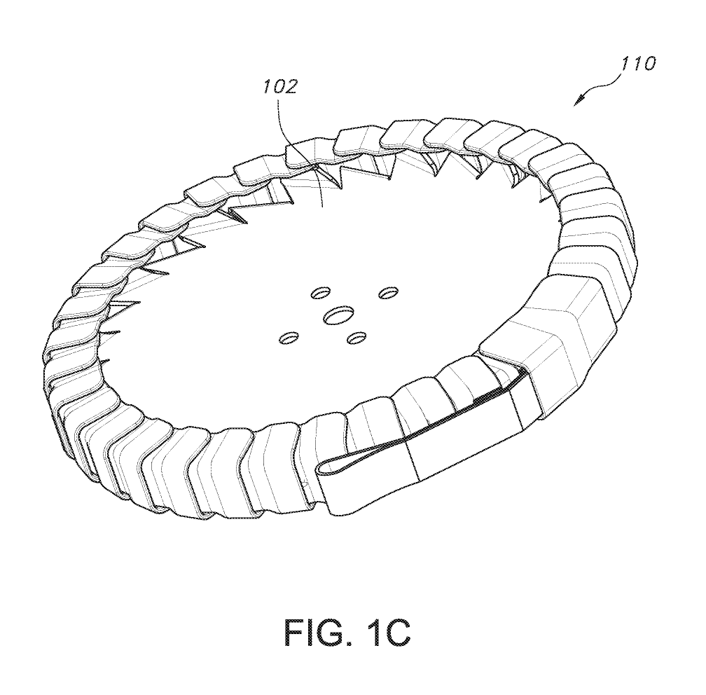

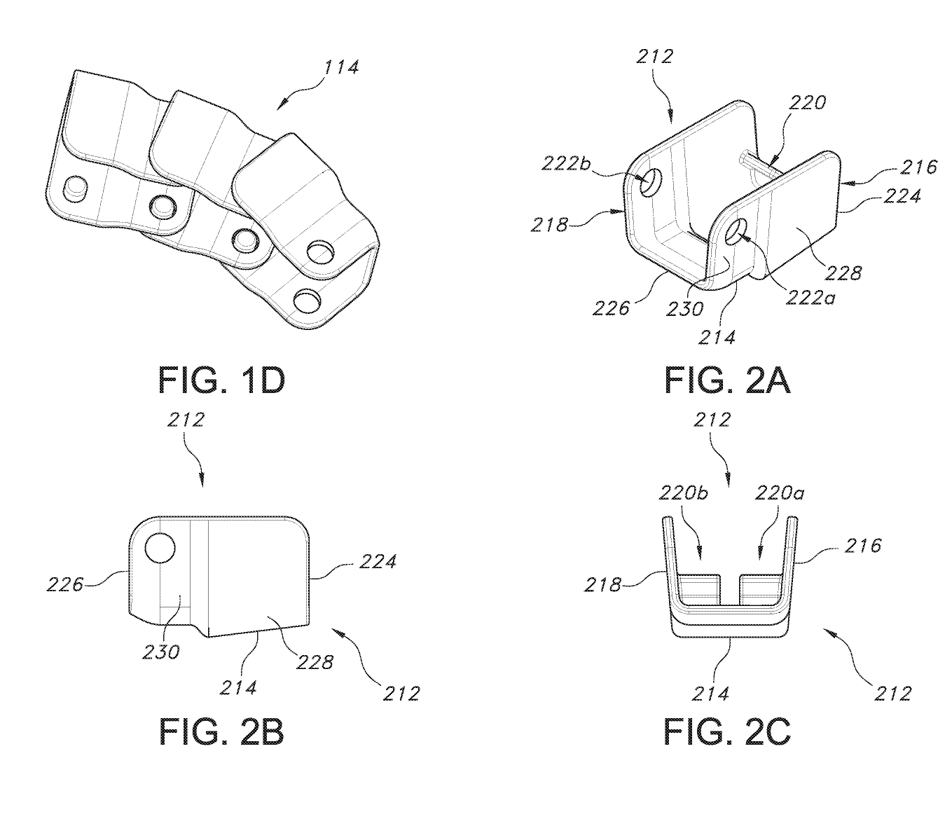

Reference is now made to the figures, which illustrate various embodiments of the protective blade guard of the present invention. FIG. 1A shows a circular blade 102 having a plurality of irregular edges or teeth 104 on the circumference of the blade 102 and the protective guard 110 having anchor link 112, a plurality of pivoted links 114 and terminal latching link 116 with strap 118. In FIG. 1A, anchor link 112 of protective guard 110 is attached to a tooth of the circular blade 102. FIG. 1B shows protective guard 110 partially wrapped around the circumference of blade 102 and FIG. 1C shows protective guard 110 completely surrounding the circumference of blade 102 and completely covering the teeth 104 of the blade 102 with latching link 116 attached to anchor link 112. FIG. 1D illustrates a plurality of pivoted links 114 that can be added to the main body of the blade guard 110 to increase the length of the blade guard 110 to all for covering blades of a greater diameter.

FIG. 2 illustrates an anchor link according to an embodiment of the present invention. As shown in this embodiment, the anchor link 212 includes a top wall 214 and two opposing side walls 216, 218, that form a continuous U-shaped body for covering teeth 104 of a blade 102. The anchor link 212 further includes a member 220 at the first end 224 that extends between the opposing side walls 216 and 218 and attaches to a tooth 104 of a blade 102 and apertures 222a, 222b on the opposing side walls 216, 218 at the second end 226. The apertures 222a and 222b are for attaching a pivoted link 312 to the anchor link 212. In some embodiments, the member 220 can be formed by two members 220a and 220b extending from but not completely traversing between the two opposing side walls 216, 218. The gap between the two members 220a and 220b allows the user to attach the anchor link 212 to blades 102 with larger teeth 104. The anchor link 212 has a first section 228 with an interior perimeter that is greater than the exterior perimeter of the second section 230. The second section 230 is designed to be inserted into a pivoted link 312. The anchor link 212 can be made of a polymeric material and with different colors, e.g., red or yellow, and have a length ranging from about 1 inch to about 4 inches and a width ranging from about 0.75 inches to about 1.5 inches. However, the dimensions of the anchor link 212 and the other components of the protective blade guard 110 are intended to serve as an example and are not intended to limit the scope of the present invention.

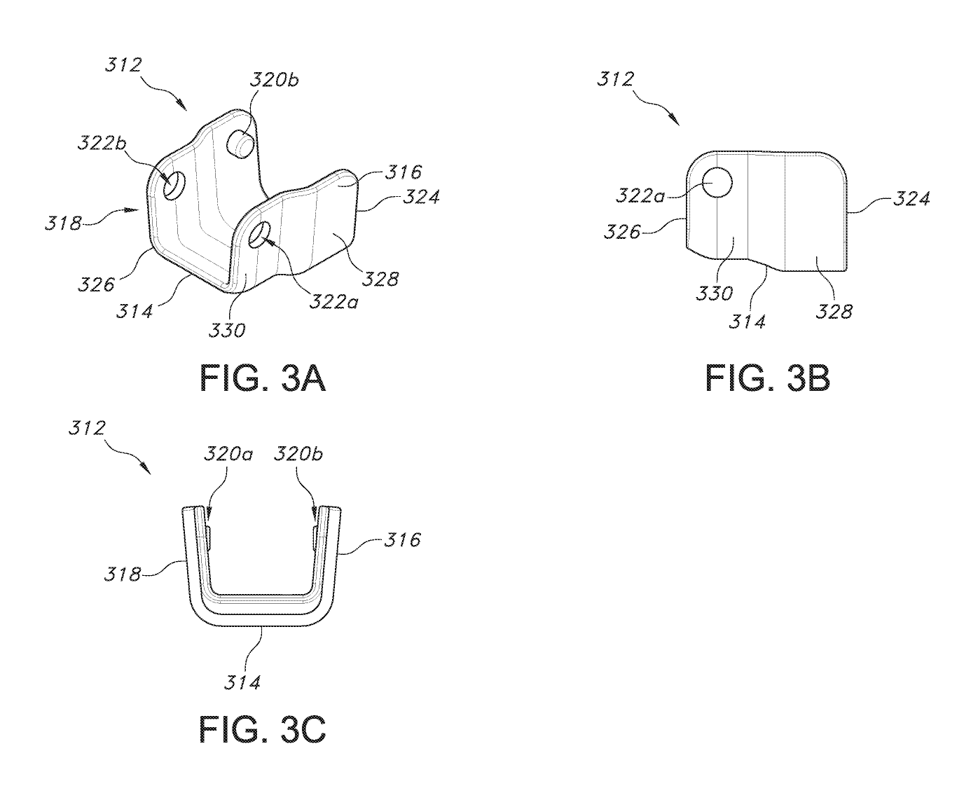

FIG. 3 illustrates a connected pivoted link 312 according to an embodiment of the present invention. The pivoted link 312 includes a top wall 314 and two opposing side walls 316, 318, that form a continuous U-shaped body for covering the teeth 104 of a blade 102. The pivoted link 312 has studs 320a and 320b at a first end 324 for attaching the pivoted link 312 to another pivoted link 312 or to an anchor link 212. The pivoted link 312 also has apertures 322a, 322b at a second end 326 for receiving the studs 320a, 320b of another pivoted link 312 or the studs 420a, 420b of a terminal latching link 412. As shown, the studs 320a, 320b and mating apertures 322a, 322b are round in shape to facilitate pivoting of the links 312 relative to each other. As further shown in this embodiment, the pivoted link 312 has a first section 328 with studs 320a, 320b and a second section 330 with apertures 322a, 322b. The interior perimeter of the first section 328 is greater than the exterior perimeter of the second section 330 so that when adjoining pivoted links 312 are connected, the first section 328 easily fits over the second section 330 to form a continuous shield when placed over a circular blade 102. The pivoted link 312 can be made of a polymeric material and have various colors, e.g., red or yellow, and have a length ranging from about 1 inch to about 4 inches and a width ranging from about 0.75 inches to about 1.5 inches.

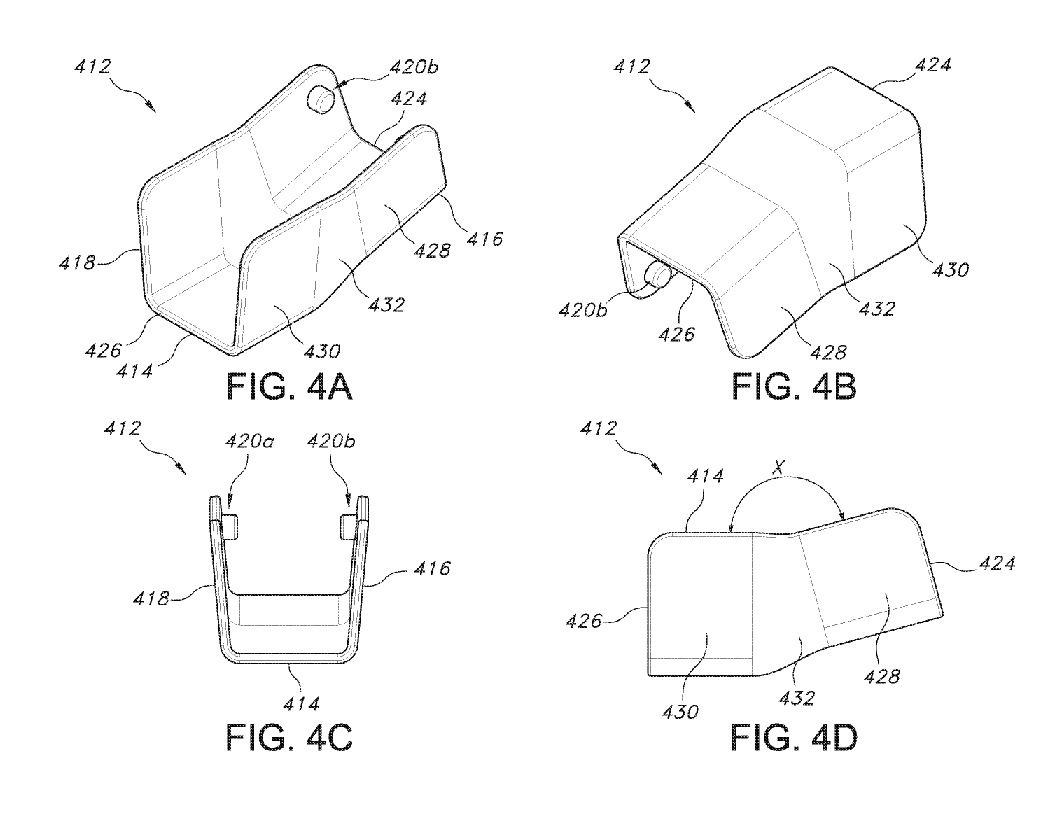

FIG. 4 illustrates a latching link 412 that includes a top wall 414 and two opposing side walls 416, 418 that form a continuous U-shaped body for covering the teeth 104 of a blade 102. The latching link 412 has studs 420a, 420b extending from the interior side walls 416, 418 on the first end 424 for attaching to the apertures 322a, 322b of a pivoted link 312. The latching link 412 has a first section 428 that extends from the first end 426 to an intermediate point and has an interior perimeter defined by the top wall 414 and two opposing side walls 416, 418. The interior perimeter of the first section 428 is greater than the exterior perimeter of the second section 330 of the pivoted link 312. The latching link 412 has a second section 430 with an interior perimeter that is greater than the exterior perimeter of the anchor link 212 so that the second section 430 of the latching link 412 can be fitted over the anchor link 212. The latching link 412 can be made of a polymeric material, red or yellow in color, and have a length ranging from about 1 inch to about 6 inches and a width ranging from about 0.75 inches to about 1.5 inches.

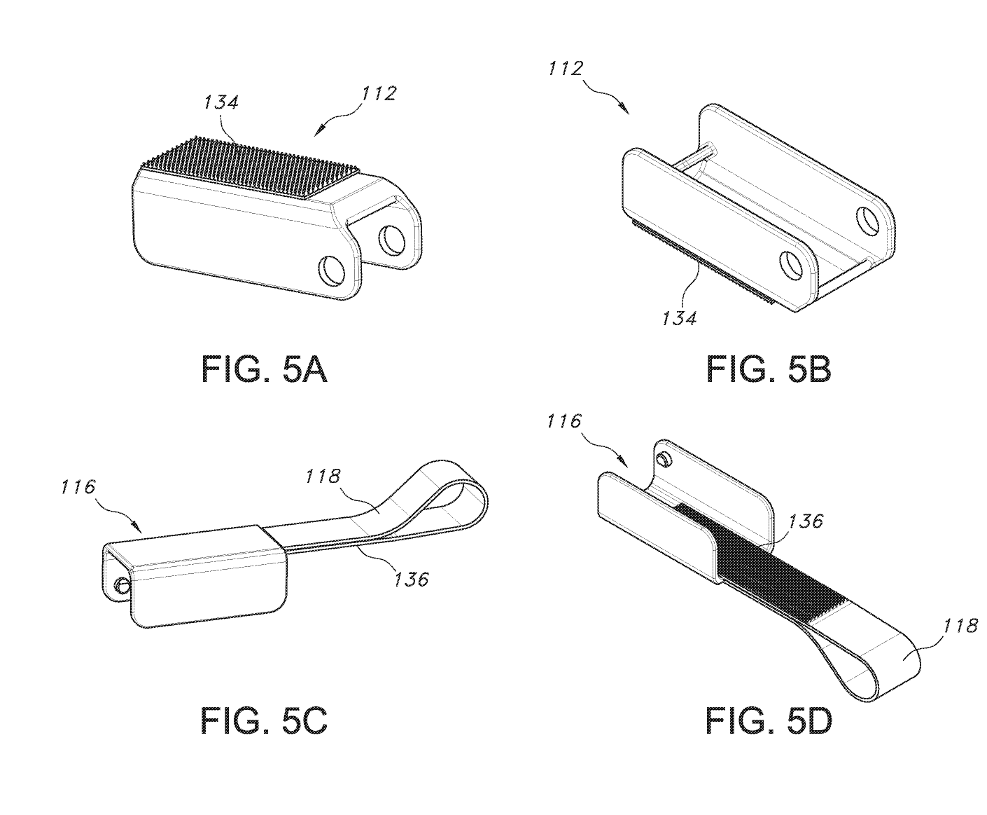

FIGS. 5A-D show a preferred embodiment of the anchor link 112 and latching link 116 in which a strip 134 of VELCRO® is attached to the top wall of the anchor link 112 and a corresponding strip 136 of VELCRO® is attached to the strap 118 on the latching link 116. When the latching link 116 is placed over the anchor link 112, the VELCRO® secures them together.

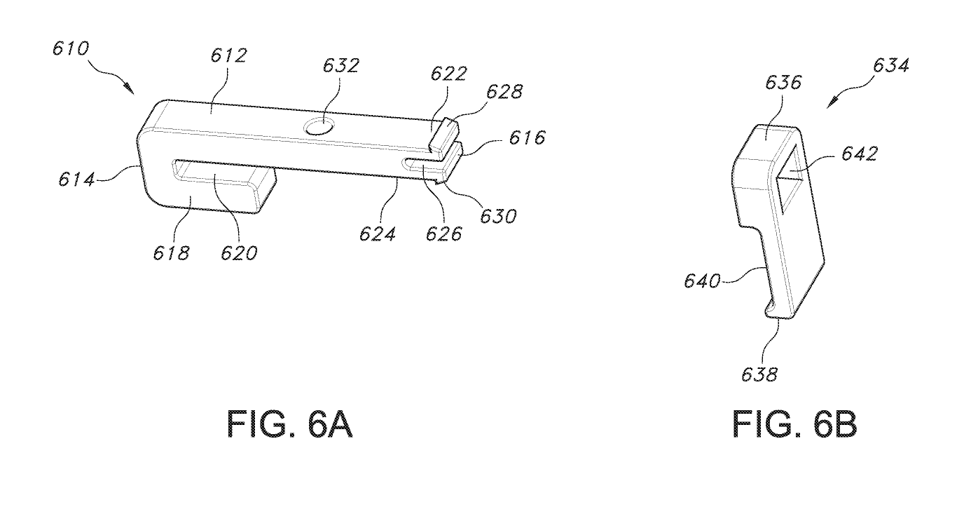

FIGS. 6A-B show a two-part locking device 610 that is used to secure the protective guard 100 onto a circular blade 102. The locking device 610 has an elongate member 612 having a U-shaped first end 614 formed by a curved member 618 that defines a slot 620 and a forked second end 616 with first and second distal ends 622, 624 with a slot 626 in between. The first and second distal ends 622, 624 have lips 628, 630 extending away from the slot 626. The elongate member 612 also has an aperture 632 near the second end 616. The body 634 of the second part of the two-part locking device 610 has first and second ends 636, 638 with a notch 640 on the side near the second end 638 for receiving the protective blade guard 110 and an aperture 642 on the first end 636 for receiving the forked second end 616 of the elongate member 612.

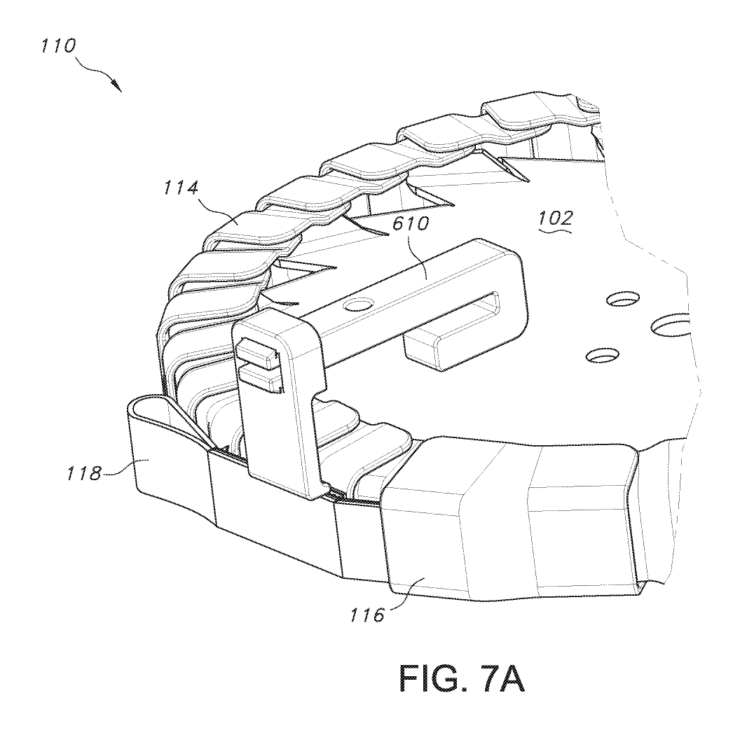

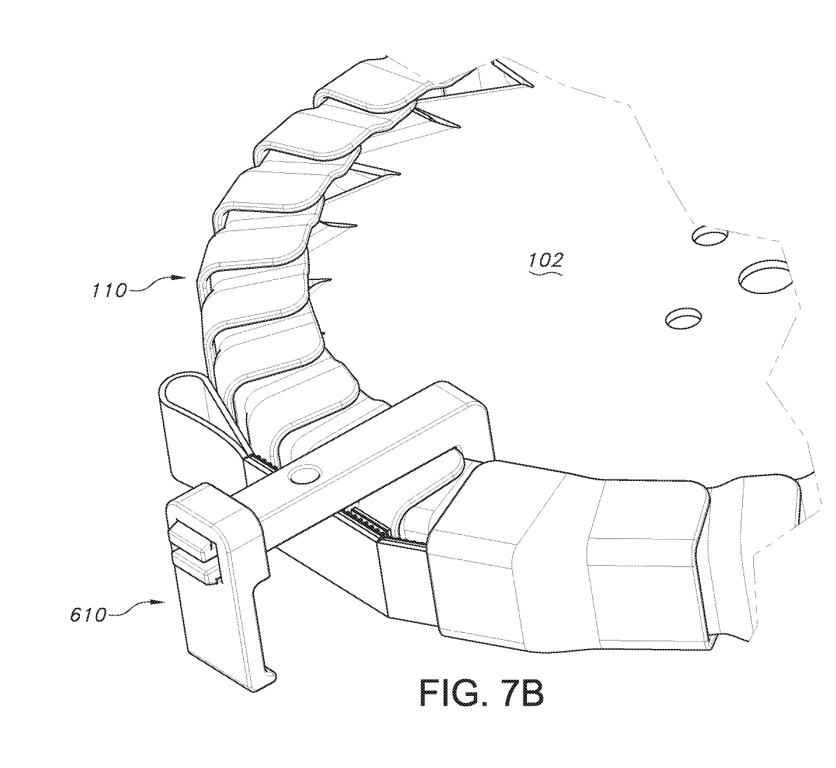

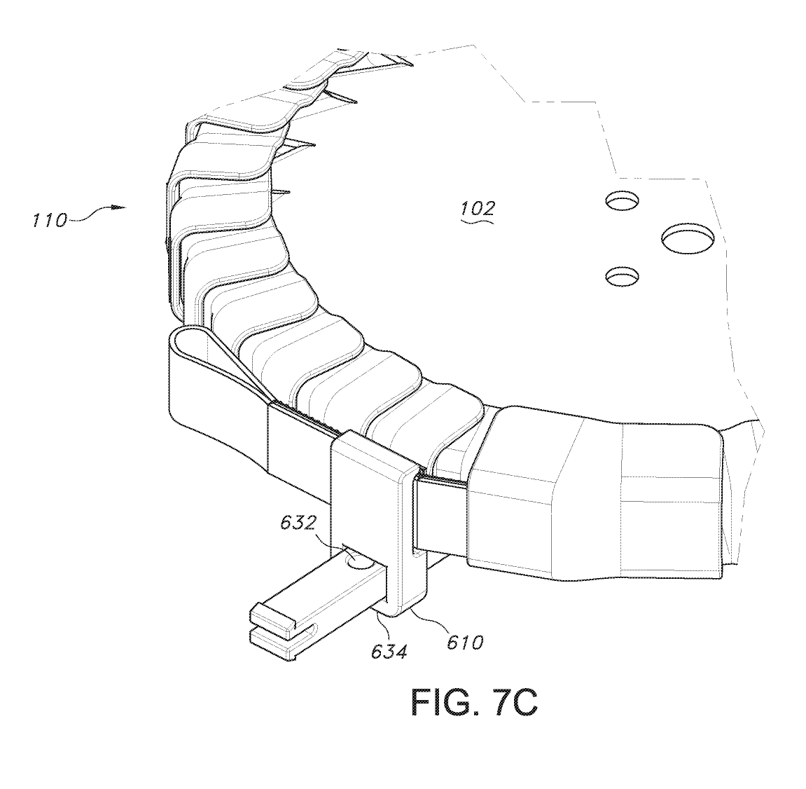

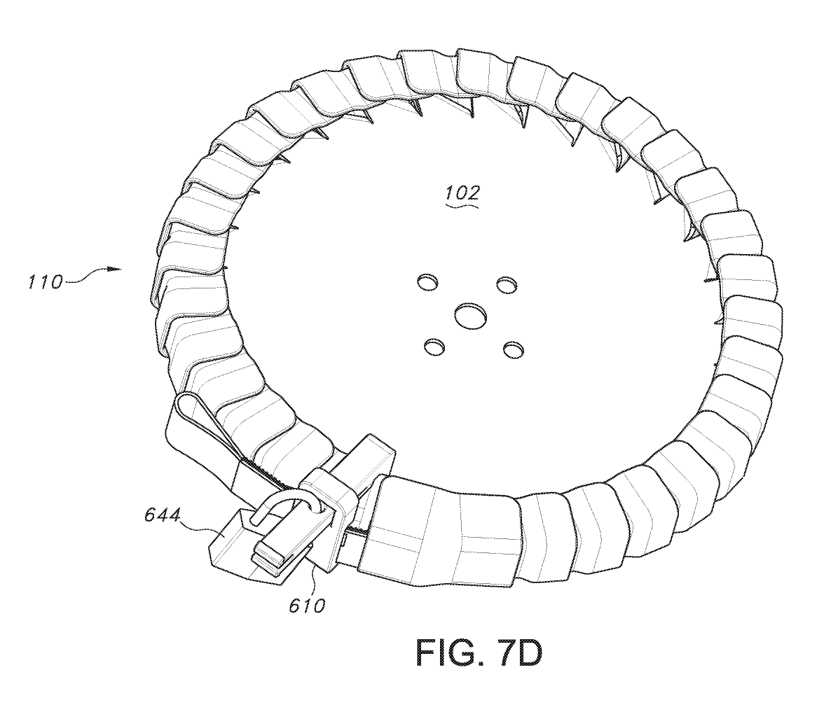

FIGS. 7A-7D show the two-part locking device 610 shown in FIGS. 6A-B as it is attached to a protective blade guard 110 that is installed on a circular blade 102. The two-part locking device 610 fits over the latching link 116 and the elongate member 612 passes through the aperture 642 in the body 634 of the second part of the locking device 610. After the aperture 632 in the elongate member 612 of the first part passes through the aperture 642 in the second part, a lock 644 can be inserted in the aperture 642 to secure the locking device 610 to the protective guard 110.

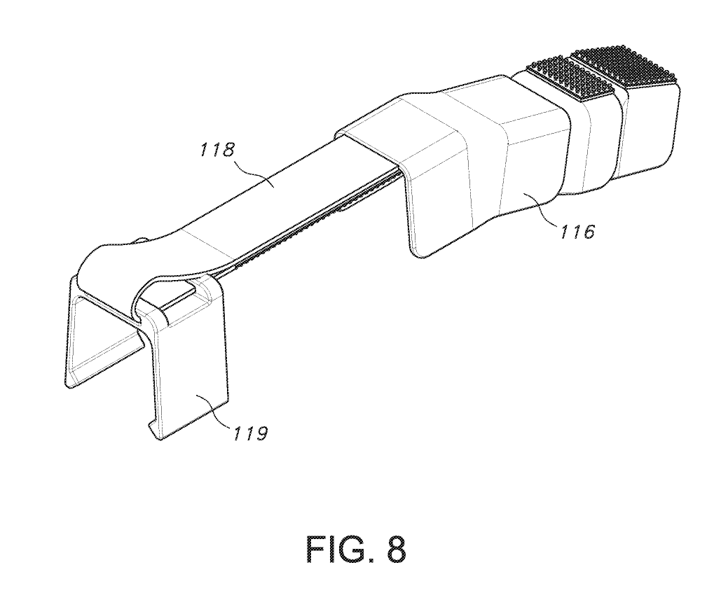

FIG. 8 shows an embodiment of the latching link 116 that has a U-shaped clip 119 attached to the end of the strap 118. After the latching link 116 is installed on the anchor link 112 (see FIGS. 1A, 1C), the clip 119 is attached to one of the connected pivoted links 114 to further secure the protective guard 110 to the circular blade 102.

Only the preferred embodiment of the present invention and examples of its versatility are shown and described in the present invention. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

We claim:

1. A protective guard for a circular blade having a plurality of projecting edges along the circumference, the protective guard comprising:
an anchor link comprising a first member;
a latching link detachably connectable to the anchor link; and
a plurality of connected pivoted links extending between and connected to the anchor link and the latching link,
wherein the first member is adapted to engage one of the plurality of projecting edges of the circular blade, the plurality of connected pivoted links are adapted to cover the plurality of projecting edges along the circumference of the circular blade and the latching link is connected to the anchor link to secure the protective guard to the circular blade.

2. The protective guard according to claim 1, wherein the anchor link has a U-shaped body comprising a first side wall and a second side wall extending downwardly from opposing sides of a top wall to define an interior and an exterior, a first open end, and a second open end, wherein the first member extends from the interior of the first side wall towards the second side wall at the first open end and each of the first and second side walls has an aperture at the second open end.

3. The protective guard according to claim 2, wherein the first member of the anchor link extends between the first and second side walls.

4. The protective guard according to claim 2, wherein a second member extends from the interior of the second side wall of the anchor link towards the first member, and wherein the first and second members define a space therebetween.

5. The protective guard according to claim 1, wherein the latching link has a U-shaped body comprising a first side wall and a second side wall extending downwardly from opposing sides of a top wall to define an interior and an exterior, a first open end, and a second open end, wherein a latching device extends from the first end and a stud extends from the interior of each of the first and second side walls at the second end, and wherein the studs connect the latching link to one of the plurality of connected pivoted links.

6. The protective guard according to claim 5, wherein each of the plurality of connected pivoted links has an exterior perimeter, wherein the second open end of the U-shaped body of the latching link has an interior perimeter formed by the first side wall, the second side wall and the top wall, and wherein the interior perimeter is greater than the exterior perimeter of each of the plurality of connected pivoted links.

7. The protective guard according to claim 5, wherein the U-shaped body of the latching link further comprises a third section disposed between the first and second sections.

8. The protective guard according to claim 5, wherein the exterior top wall of the first section of the latching link is angularly disposed to the exterior top wall of the second section of the latching link at an angle of from 160 to 175 degrees.

9. The protective guard according to claim 1, wherein each of the plurality of connected pivoted links has a U-shaped body comprising a first side wall and a second side wall extending downwardly from opposing sides of a top wall to define an interior and an exterior, a first open end, a second open end, a first section having an interior perimeter formed by the first side wall, the second side wall and the top wall and extending from the first open end to an intermediate point and a second section having an exterior perimeter formed by the first side wall, the second side wall and the top wall and extending from the second open end to the intermediate point, wherein the interior perimeter of the first section is greater than the exterior perimeter of the second section.

10. The protective guard according to claim 9, wherein each of the plurality of connected pivoted links has a first stud and a second stud extending from the interior of the first and second side walls, respectively, at the first end and a first aperture and a second aperture extending through the first and second side walls, respectively, at the second end, wherein a first link of the plurality of connected pivoted links is connected to a second link of the plurality of connected pivoted links by inserting the second end of the first link into the first end of the second link so that the first and second studs of the second link are pivotably engaged by the first and second apertures of the first link.

11. The protective guard according to claim 1, wherein the latching link comprises a latching device formed by a flexible member having top and bottom sides, wherein the top side is attached to the interior of the top wall of the latching link and the bottom side comprises a first detachably engageable surface, wherein the exterior top wall of the anchor link comprises a second detachably engageable surface, and wherein the latching link and the anchor link are connected and disconnected by engaging and disengaging the first and second detachably engageable surfaces.

12. The protective guard according to claim 1, wherein the anchor link, the latching link and/or the plurality of connected pivoted links comprise a polymeric material.

13. The protective guard according to claim 1, wherein the anchor link has a first part of a hook and loop fastener on an outer surface thereof and the latching link has a second part of the hook and loop fastener on an inner surface thereof, and wherein the hook and loop fastener are engaged to connect the latching link and the anchor link.

14. The protective guard according to claim 1, wherein the latching link includes a handle or a latching device with a U-shaped clip that is detachably connected to the anchor link.

15. The protective guard according to claim 1 further comprising a locking device comprising a first part and a second part, the first part comprising an elongate member having a U-shaped first end, a forked second end with two distal ends that define a slot, and an aperture extending through top and bottom surfaces at the second end, wherein the two distal ends have a lip formed on each of the top and bottom surfaces of the elongate member, and the second part comprising a substantially flat rectangular body with a notch on a first end and an aperture on the second end, the aperture is adapted to receive the forked second end of the first part and the lips are adapted to secure the first part to the second part when the locking device is placed over the latching link.

16. A protective guard for a circular blade having a plurality of projecting edges along the circumference, the protective guard comprising:
an anchor link having a U-shaped body comprising a first side wall and a second side wall extending downwardly from opposing sides of a top wall, a first open end, and a second open end, wherein a first member extends from the first side wall towards the second side wall at the first open end and, at the second open end, each of the first and second side walls has either a stud on the interior or an aperture therethrough;
a latching link detachably connectable to the anchor link; and
a plurality of connected pivoted links extending between and connected to the anchor link and the latching link, wherein each pivoted link has a U-shaped body and comprises a first side wall and a second side wall extending downwardly from opposing sides of a top wall to define an interior and an exterior, a first open end, a second open end, a first section having an interior perimeter and extending from the first open end to an intermediate point and a second section having an exterior perimeter and extending from the second open end to the intermediate point, wherein the interior perimeter is greater than the exterior perimeter, wherein the first member is adapted to engage one of the plurality of projecting edges of the circular blade, the plurality of connected pivoted links are adapted to cover the plurality of projecting edges along the circumference of the circular blade and the latching link is connected to the anchor link to secure the protective guard to the circular blade.

17. The protective guard according to claim 16, wherein each of the plurality of connected pivoted links has a first stud and a second stud extending on the interior of the first and second side walls, respectively, at the first end and a first aperture and a second aperture extending through the first and second side walls, respectively, at the second end, wherein a first link of the plurality of connected pivoted links is connected to a second link of the plurality of connected pivoted links by inserting the second end of the first link into the first end of the second link so that the first and second studs of the second link are pivotably engaged by the first and second apertures of the first link, and wherein the studs and apertures are used to connect a first of the plurality of connected pivoted links to the anchor link and a last of the plurality of connected pivoted links to the latching link.

18. The protective guard according to claim 16, wherein the first member extends between the first and second side wall of the anchor link.

19. The protective guard according to claim 16, wherein a second member extends from the second side wall of the anchor link towards the first member, and wherein the first and second members define a space therebetween.

20. The protective guard according to claim 15, wherein the latching link has a U-shaped body comprising a first side wall and a second side wall extending downwardly from opposing sides of a top wall to define an interior, an exterior and an interior perimeter, a first open end, and a second open end, wherein a latching device extends from the first end and at the second open end, each of the first and second side walls has either a stud on the interior or an aperture therethrough, and wherein the second section of one of the plurality of connected pivoted links is inserted in the second end of the latching device.

21. The protective guard according to claim 16, wherein the latching device on the latching link is formed by a flexible member having top and bottom sides, wherein the top side is attached to the interior of the top wall and the bottom side comprises a detachably engageable surface.

22. A protective guard for a circular blade having a plurality of projecting edges along the circumference, the protective guard comprising:
an anchor link having a U-shaped body comprising a first side wall and a second side wall extending downwardly from opposing sides of a top wall to define an interior, an exterior and an exterior perimeter, a first open end, and a second open end, wherein a first member extends from the first side wall towards the second side wall at the first open end and, at the second open end, each of the first and second side walls has either a stud on the interior or an aperture therethrough;
a latching link having a U-shaped body comprising a first side wall and a second side wall extending downwardly from opposing sides of a top wall to define an interior, an exterior and an interior perimeter, a first open end, and a second open end, wherein a latching device extends from the first open end and, at the second open end, each of the first and second side walls has either a stud on the interior or an aperture therethrough; and
a plurality of connected pivoted links extending between and connected to the anchor link and the latching link, wherein each pivoted link has a U-shaped body and comprises a first side wall and a second side wall extending downwardly from opposing sides of a top wall to define an interior and an exterior, a first open end, a second open end, a first section having an interior perimeter formed by the first side wall, the second side wall and the top wall and extending from the first open end to an intermediate point and a second section having an exterior perimeter formed by the first side wall, the second side wall and the top wall and extending from the second open end to the intermediate point, wherein the interior perimeter of the first section is greater than the exterior perimeter of the second section, wherein the interior perimeter of the first section is greater than the exterior perimeter of the anchor link, and wherein the interior perimeter of the latching link is greater than the exterior perimeter of the second section,
wherein the first member of the anchor link is adapted to engage one of the plurality of projecting edges of the circular blade, a first of the plurality of connected pivoted links engages the anchor link, the plurality of connected pivoted links is adapted to cover the plurality of projecting edges along the circumference of the circular blade, the second open end of the latching link engages a last of the plurality of connected pivoted links, and the latching link is detachably connected to the anchor link to secure the protective guard to the circular blade.
